(19) United States
(12) Patent Application Publication
(10) Pub. No.: US 2014/0223579 A1
(43) Pub. Date: Aug. 7, 2014

(54) Software and Method for Securing Information Online

(71) Applicant: Afif Haidar, Brooklyn, NY (US)

(72) Inventor: Afif Haidar, Brooklyn, NY (US)

(21) Appl. No.: 13/760,323

(22) Filed: Feb. 6, 2013

(51) Int. Cl. G06F 21/60

(52) U.S. Cl. CPC G06F 21/60
USPC 726/28

(57) ABSTRACT

A method for securing information online comprises prompting a user to enter personal information and financial information just one time or the first time only, storing the personal information and financial information, prompting the user to indicate a limited quantity of the personal information and financial information to be shared with a client web server, providing a limited-time password usable at the client web server, receiving a request from the client web server for information regarding the user based at least in part on use of the one-time password by the user at the client web server, and providing the limited quantity to the client web server.

### BACKGROUND OF THE INVENTION

The present invention relates to a single password sign-on for efficiently and securely accessing and using any compliant internet site.

Today people use internet sites that require user information, like user's email/full name/date of birth/social security number/address/optional credit card. They often require the user to register and create a new user ID/account and password. The user has to create an account with each such site and has to specify a user ID and password.

The user is required to maintain and keep track of these user ID's and passwords created for each site. This becomes very tedious and hard to manage as more and more people are taking advantage of online services like receiving online statements from their banks/credit card companies/utility companies/and so on.

Also, as people are required to create a separate password for each site; it's very hard to keep remembering these passwords. Some users might get discouraged from using some sites that require user login/password. Some users might also choose to use same password for several sites and/or choose a password that's not very secure which presents a significant security risk.

Also, for sites that require the use of a credit card, the user has to provide the full credit card details (i.e., full name as it appears on credit card, account number, expiration date and security code). An unscrupulous site/merchant can misuse this info as it has full access to the credit card in question. A site/merchant that's hacked will expose all these full credit card details to hackers. Currently, other methods have not gained popularity since they require special software to be implemented and do not offer single password management.

As can be seen, there is a need for solutions to these and other problems.

### SUMMARY OF THE INVENTION

In one aspect of the present invention, a method for securing information online comprises: prompting a user to enter personal information and financial information; storing the personal information and financial information; prompting the user to indicate a limited quantity of the personal information and financial information to be shared with a client web server; providing a limited-time password usable at the client web server; receiving a request from the client web server for information regarding the user based at least in part on use of the one-time password by the user at the client web server; and providing the limited quantity to the client web server.

In one aspect, the limited-time password is usable exactly one time and expires after the first use. In one aspect, the personal information comprises at least two of a name, address, date of birth, and social security number. In one aspect, the financial information comprises at least one of a credit card number, debit card number, and bank account number. In one aspect, the limited quantity comprises a maximum financial charge allowable by the client web server.

In another aspect of the present invention, a system for securing information online comprises: a machine; and a program product comprising machine-readable program code for causing, when executed, the machine to perform the method as described.

In another aspect of the present invention, a method for securing information online comprises: entering personal information and financial information on a provider web server just one time or the first time only; determining user information required to access a client web server; indicating on the provider web server a limited quantity of the personal information and financial information to be shared with the client web server; receiving a limited-time password usable at the client web server; and using the limited-time password at the client web server to thereby authorize transfer of the limited quantity to the client web server.

In one aspect, the method further comprises receiving an indication from the client web server regarding information necessary to register with, or login to or use services provided by the client web server.

These and other features, aspects and advantages of the present invention will become better understood with reference to the following drawings, description and claims.

### BRIEF DESCRIPTION OF THE DRAWINGS

FIG. 1: shows a functional diagram of one embodiment of the invention.

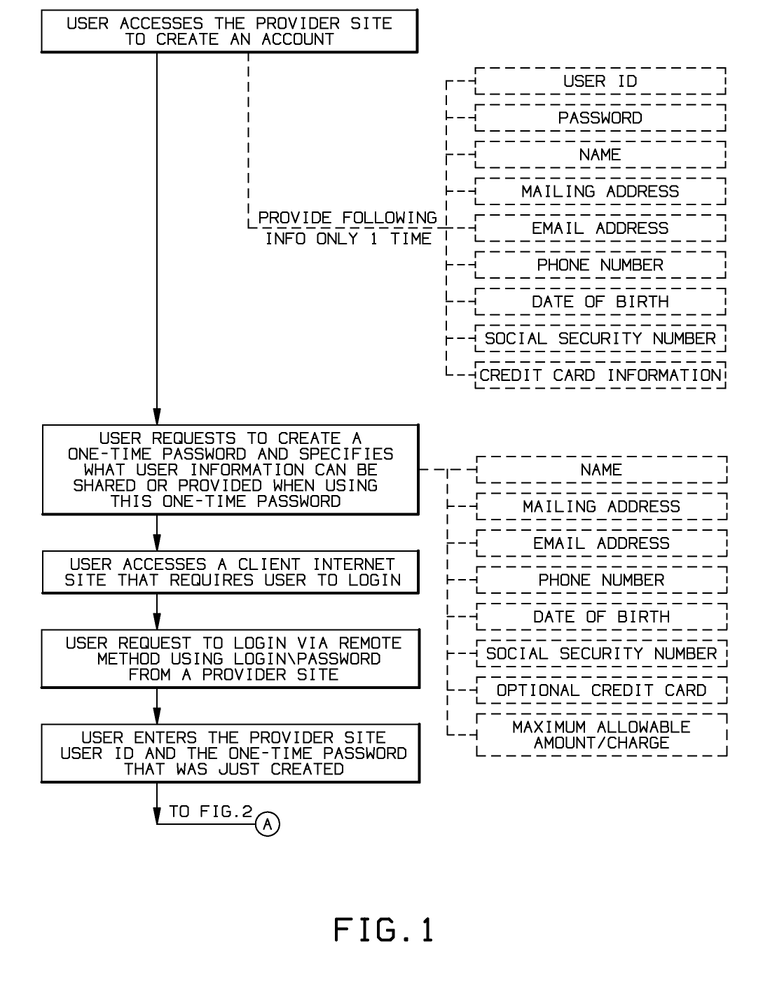

FIG. 2: shows a continuation of functional diagram FIG. 1.

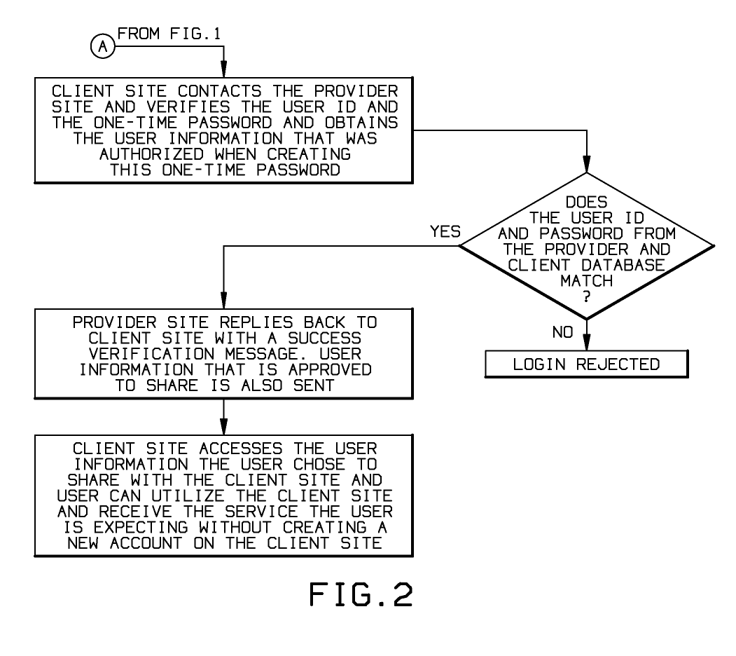

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present invention allows user to only remember one password to access any site (that can connect to the provider site) and allows the user to control the amount of a credit card charge while not providing any credit card information to the site/merchant itself (client web server/site). This invention allows the user to control how much personal info to share with any site since the one-time password created is tied to only the user's info that user chose to share.

In one aspect of the present invention, a centrally located site (provider site) that hosts the main user account can be used to provide a user ID and password that can be used to log in to any site that can contact the central/provider site and retrieve the required info.

For example, a user goes to the centrally located site, called a provider site, and creates an account with his/her info (like user's email/full name/date of birth/social security number/address/optional credit card). This is the only user ID and password that the user must remember.

When user then visits various sites on internet, called client sites (e.g., a merchant), the user would first log in to the provider site, generate a one-time password and save it. The user then would go to any client site on the internet that can connect to the provider site, click on a link to login through the provider site and provide the provider site user ID and the one-time password.

The client site contacts the provider site and retrieves the user's info including any of the following: user's email/full name/date of birth/social security number/address/optional credit card. Now the client has all the info needed to serve the user.

When user logs in to the provider site to create the one-time password, the user has options in terms of what personal info to share when using this one-time password. For example, the user might only allow a name/address to be shared when the client site contacts the provider site. Or in addition a user might allow a credit card transaction to be allowed by the client site where the maximum charge is up to a specific account. This way, no credit card is used on the client site and the user does not have to worry about the client site/merchant charging more than the expected or authorized amount, so a user may rest assured knowing the client site can only charge up to a maximum amount. The user now only has to remember one user ID and one password and optionally can dictate a maximum amount a site can charge.

This invention is an improvement on what currently exists. Other single sign-on methods do not allow for single password usage where users only have to remember one password. Also other single sign-on methods require special software to be loaded in order to share user registration information. Also, other single sign-on methods allow the user to store the various passwords in one site, but still require the user to create multiple accounts on various client sites each with a user ID and password. Also, other methods do not allow the user to create a maximum credit card charge amount when allowing a site to charge against user's credit card.

This invention allows the user to only remember one password; which allows user to log in to any site that can contact the main provider site and allows the user to control what to share with client sites and maximum credit card amount charge. This invention provides enhanced user password security where the user enters a one-time password to access a client site. Once this one-time password is used, it cannot be re-used again, thus offering a solid defense mechanism, and the user need not worry about changing passwords or who has access to his/her password. Once a password is used, it is rendered invalid and the user must login to the provider site to create a new one-time password in order to log in again to any client site.

With other methods, the user still must create a password for each site he/she would like to visit and user does not have control on the maximum amount he/she can be charged on his/her credit card.

This invention allows a user to only remember one password to access any site (that can connect to the provider site) and allows the user to control the amount of a credit card charge while not providing any credit card info the site/merchant itself. This invention allows user to control how much personal info to share with any site since the one-time password created is tied to only the user's info that user chose to share.

One aspect of the present method includes:

1. User accesses a client site that requires the user to login.
2. User accesses the provider site and logs using his/her user ID and the single password that the user must remember.
3. User requests to create a one-time password and specifies what user info (like user's email/full name/date of birth/social security number/address/optional credit card) can be shared or provided when using this one-time password. If the user elects to allow credit card access, the user may also specify maximum allowed amount/charge.
4. User saves this one-time password.
5. User goes back to the client site that required the user to login and chooses to login via the provider site and not using an account/user ID/password that is only valid on the client site.
6. User enters his/her provider user ID and the one-time password that was just created.
7. Client site contacts the provider site and verifies the user ID and the one-time password and obtains the user info that was authorized when creating this one-time password.
8. Client site now has the user info that the user chose to share with the client site and the user now can take advantage of the client site and receive the service he/she is expecting without having to create a new account on the client site.

According to the present invention, a user can login to internet sites without having to create an account/user ID/password for each site and have control as to what personal info to share for each login. By first creating an account on the main central/provider site, a user is now able to access any site that can contact the provider site. If a client site is able to verify a user by contacting the central/provider site, the client site is able to retrieve all the info that user chose to share with the client site.

When the user chooses to login to the client site using the central/provider user ID, the client site can inform the user about the information that it requires to allow access to it so that the user knows what info to share/allow when creating the one-time password on the provider site.

If the attempt by the client site to contact the provider site is successful, using the provider site's user ID and the one-time password, the next step is for the client site to retrieve the user's info that is allowed to be shared using the one-time password provided. Once this is successful, the client site now has some user info that the user chose to share with it.

The client site then decides whether the user info retrieved is enough to serve the user; if not, the client site can inform what info is still missing and the user has the option to go back to the provider site and create a new one-time password and share additional info requested by the client site.

### How To Use The Invention:

By following the above-listed steps, a user does not have to create an account for each internet site and have control over what info is shared on each site for each login session. First a provider website is created where a user would create an account with a user ID and password. Then within the user account, a user fills in his/her information.

The site would also allow creating a dynamic one-time password and specify what user info can tied/shared with this password (for credit card selection, the site would also allow user to specify a maximum charge amount). The provider site may also allow remote access where another site might send a request via https (secure connection) to validate the one-time password that the user would enter and to allow retrieval of the user info that is allowed to be shared using the one-time password.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

1. A method for securing information online, comprising:
prompting a user to enter personal information and financial information onto a central provider web server;
storing the personal information and financial information on the central provider web server;
prompting the user to indicate a limited quantity of the personal information and financial information on the central provider web server, wherein the limited quantity of the personal information and financial information is to be shared with a client web server;
providing a limited-time password associated with the limited quantity of the personal information and financial information, wherein the limited-time password comprises a limited amount of uses and an expiration, and wherein the limited-time password is usable at the client web server;
prompting the user to input the limited-time password to the client web server, thereby logging into the client web server;
requesting information regarding the user to be sent to the client web server from the central provider server once the client web server has received the limited-time password; and
providing the limited quantity associated with the limited-time password to the client web server.

2. The method as claimed in claim 1, wherein the limited-time password is usable exactly one time and expires after the first use.

3. The method as claimed in claim 1, wherein the personal information comprises at least two of a name, address, date of birth, and social security number.

4. The method as claimed in claim 1, wherein the financial information comprises at least one of a credit card number, debit card number, and bank account number.

5. The method as claimed in claim 1, wherein the limited quantity comprises a maximum financial charge allowable by the client web server.

6. A system for securing information online, comprising:
a machine; and
a program product comprising machine-readable program code for causing, when executed, the machine to perform the method as claimed in claim 1.

7.-11. (canceled)

12. The method as claimed in claim 1, further comprising receiving an indication from the client web server to the central providers web server regarding information necessary to register with the client web server.

13. A method for securing information online, comprising:
prompting a user to enter personal information and financial information onto a provider web server;
storing the personal information and financial information on the provider web server;
displaying a minimum requirement of information to allow access to a client web server to the user;
prompting the user to indicate a limited quantity of the personal information and financial information on the provider web server based on the minimum requirement, wherein the limited quantity of the personal information and financial information is to be shared with the client web server;
providing a limited-time password associated with the limited quantity of the personal information and financial information, and wherein the limited-time password is usable at the client web server;
prompting the user to input the limited-time password to the client web server, thereby logging into the client web server;
requesting information regarding the user to be sent to the client web server from the central provider server once the client web server has received the limited-time password; and
providing the limited quantity associated with the limited-time password to the client web server.
